(19) United States
(12) Patent Application Publication
(10) Pub. No.: US 2017/0291981 A1
(43) Pub. Date: Oct. 12, 2017

(54) METHOD FOR PREPARING THERMOPLASTIC POLYURETHANE PELLETS

(71) Applicant: ROQUETTE FRERES, Lestrem (FR)

(72) Inventors: René SAINT-LOUP, Lomme (FR); Jérôme GIMENEZ, Bron (FR); Henri SAUTEL, Saint Just Chaleyssin (FR)

(21) Appl. No.: 15/513,883

(22) PCT Filed: Oct. 7, 2015
(86) PCT No.: PCT/FR2015/052689

§ 371 Date: Mar. 23, 2017

(30) Foreign Application Priority Data
Oct. 9, 2014 (FR) 14 59684

(51) Int. Cl. C08G 18/32; B29B 9/06; C08G 18/42; C08G 18/48; C08G 18/76

(52) U.S. Cl. CPC C08G 18/3218; C08G 18/4854; C08G 18/7671; C08G 18/4238; B29B 9/06; B29K 2075/00

(57) ABSTRACT

The present invention relates to a method for manufacturing thermoplastic polyurethane pellets by means of reactive extrusion of: a long macrodiol with a molecular weight of 500 to 3000 g/mol; a diisocyanate; at least one chain extender comprising a dianhydrohexitol; and a polymerization catalyst. The invention also relates to the resulting thermoplastic polyurethane pellets.

The present invention relates to a method for preparing thermoplastic polyurethane (TPU) pellets by reactive extrusion, using isosorbide as chain extender, and also to the thermoplastic polyurethane pellets obtained in this way.

TPUs are conventionally obtained by reacting a macrodiol, especially a polyether glycol or a polyester glycol having terminal hydroxyls, a chain extender and an isocyanate compound, optionally in the presence of a polymerization catalyst. Various compounds are described in the literature for each of these reagents. TPUs are segmented polymers comprising flexible segments provided by the long macrodiols and rigid segments provided by the isocyanate compound and the chain extender. These alternating rigid and flexible segments give the TPUs excellent elastic properties. The chain extender is generally a glycol, mainly 1,4-butanediol (BDO).

TPUs may be prepared in different ways. The conventional methods require the in situ preparation of the polymer just before shaping of the final product. Other methods make it possible to store the TPUs in the form of pellets. According to the latter methods, mention may be made, for example, of the method consisting in mixing the reagents in a wide, flat container, reacting and curing the mixture of reagents to form a TPU plate, cutting and grinding the TPU plate into pieces, then extruding the pieces into pellets. Moreover, there is another method, which is a reactive one-step method, referred to as reactive extrusion. The latter consists in introducing the reagents into an extruder in which the mixing and the reaction take place simultaneously. Generally, the chain extender and/or the isocyanate compound are each introduced separately from the other reagents and the materials which react are transported from the feed section to the output die, where the polymer is shaped, cooled and pelletized.

TPUs are polyvalent polymers which may, depending on the reagents chosen and the proportions thereof, have varied applications in numerous fields. In particular, TPUs may be used for producing products requiring shaping by molding or extrusion such as parts for the automotive industry, industrial machines, electronic devices or various products for everyday life.

For a number of these applications, TPUs first and foremost provide a technical function (electrical insulation, impact protection, grip improvement, etc.) but the visual and sensory appearance of TPUs is also involved in the design of the product. For such applications, it is therefore important to be able to have TPUs having good moldability (especially for overmolding), low coloration enabling good colorability, and a supple feel while retaining good abrasion resistance.

Working with this in mind, the applicant has developed a method making it possible to obtain a TPU meeting these expectations.

The TPU obtained according to the method which is a subject of the present invention also has the advantage of being partly obtained from a raw material of natural origin. Indeed, in the current context of the gradual decrease in petroleum product resources, it is increasingly advantageous to replace products of petroleum origin with products of natural origin.

Thus, the present invention relates to a method for preparing TPU pellets by reactive extrusion, comprising:
introducing, into an extruder, a macrodiol (a) of molar mass from 500 to 3000 g/mol, a diisocyanate (b), a chain extender (c) comprising a dianhydrohexitol and a polymerization catalyst (d), said compounds (a), (b), (c) and (d) being introduced into the extruder in liquid form;
mixing the compounds (a), (b), (c) and (d) and polymerizing said mixture in the extruder; and
extruding and cutting the polymerized mixture to form the thermoplastic polyurethane pellets.

The macrodiol (a) according to the present invention denotes a polymer functionalized at chain ends by hydroxyl functions. The macrodiol has a molecular weight of between 500 and 3000 g/mol, preferably of between 700 and 2000 g/mol, more preferentially of between 800 and 1500 g/mol. The macrodiol is preferably chosen from polyether glycols, polyester glycols, polycarbonate glycols or mixtures thereof. In a particular embodiment, the macrodiol is a polyether glycol. The functionality of the macrodiol is between 1.75 and 2.2, preferably between 1.85 and 2.1, more preferentially between 1.95 and 2.05. Within the meaning of the present invention, “functionality” is intended to mean the total number of reactive hydroxyl functions per mole of polyol.

Polyether glycols or polyalkylene ether glycols denote preferably linear polyethers having two terminal hydroxyl functions. The alkylene portion may comprise 2 to 10 carbon atoms, preferably 2 to 4 carbon atoms. They may be obtained by reaction of a glycol with an epoxide. The polyether glycols according to the present invention comprise block or random copolyether glycols, especially block or random copolymers of ethylene oxide and propylene oxide. Examples of polyether glycols according to the present invention comprise poly(oxyethylene) glycol, poly(oxypropylene) glycol, poly(oxyethylene-oxypropylene) glycol, poly(oxytetramethylene) glycol (also referred to as polytetramethylene ether glycol) and mixtures thereof. The polyether glycol is preferably a poly(oxytetramethylene) glycol.

Polyester glycols denote preferably linear polyesters having two terminal hydroxyl functions. They may be obtained by linear condensation of at least one glycol with at least one dicarboxylic acid or by reacting a cyclic ester with a glycol. The polyester glycols according to the present invention comprise block or random copolyester glycols; such copolyester glycols may especially be obtained by the use of a mixture of at least two glycols and/or at least two dicarboxylic acids. The glycols used may comprise 2 to 8 carbon atoms, preferably 2 to 6 carbon atoms, such as ethylene glycol, propylene glycol, butylene glycol and 1,6-hexanediol. The dicarboxylic acids used generally have 4 to 10 carbon atoms, such as succinic acid, glutamic acid, glutaric acid, octanedioic acid, sebacic acid, maleic acid, fumaric acid, adipic acid, azelaic acid, phthalic acid, isophthalic acid and terephthalic acid. The dicarboxylic acid used may be a dicarboxylic fatty acid, that is to say a saturated or unsaturated aliphatic dicarboxylic acid comprising from 8 to 44 atoms between the acid functions, possibly being synthesized for example by dimerization of unsaturated aliphatic monocarboxylic acids or unsaturated aliphatic esters having between 8 and 22 carbon atoms such as linoleic and linolenic acid. The cyclic ester used is generally epsilon-caprolactone. Examples of polyester glycols according to the present invention comprise polyethylene glycol adipate, polypropylene glycol adipate, polypropylene-ethylene glycol adipate, polybutylene glycol adipate, polybutylene-ethylene glycol adipate, polycaprolactone diol and mixtures thereof.

Polycarbonate polyols denote preferably linear polycarbonates having terminal hydroxyl functions. They are obtained by reaction between a diol and phosgene, a chloroformate, a dialkyl carbonate or a diallyl carbonate. Diols which may be used are ethanediol, diethylene glycol, 1,3-butanediol, 1,4-butanediol, 1,6-hexanediol, 2-methyl-1,3-propanediol, 2,2-dimethyl-1,3-propanediol and 1,5-pentanediol. An example of a polycarbonate polyol according to the present invention is 2-methyl-1,3-propanediol polycarbonate.

The diisocyanate (b) used in the present invention may be aliphatic or aromatic. Examples of diisocyanates comprise ethylene diisocyanate, tetramethlyene diisocyanate, 1,6-hexamethylene diisocyanate, isophorone diisocyanate, 1,4-cyclohexylene diisocyanate, 1,3-cyclohexylene diisocyanate, 2,2′-methylenebis(cyclohexylisocyanate), 2,4′-methylenebis(cyclohexylisocyanate), 4,4′-methylenebis(cyclohexylisocyanate), 1,4-phenylene diisocyanate, 1,3-phenylene diisocyanate, 2,4-toluene diisocyanate, 2,4-tollylene diisocyanate, 2,6-tollylene diisocyanate , 3,3′-dimethyl-4,4′-diisocyanatodiphenyl, 1,5-naphthalene diisocyanate, 2,2′-diphenylmethylene diisocyanate (2,2′-MDI), 2,4′-diphenylmethylene diisocyanate (2,4′-MDI), 4,4′-diphenylmethylene diisocyanate (4,4′-MDI), metaxylylene diisocyanate (MXDI) and mixtures thereof. The diisocyanate is preferably 2,4′-diphenylmethylene diisocyanate, 4,4′-diphenylmethylene diisocyanate or mixtures thereof.

The chain extender (c) used in the present invention comprises at least one dianhydrohexitol. The term dianhydrohexitol according to the present invention denotes any compound resulting from the double dehydration of hexitols, especially of sorbitol. Examples of dianhydrohexitols comprise isosorbide, isoidide, isomannide and mixtures thereof. The dianhydrohexitol is preferably isosorbide. The chain extender (c) typically comprises at least 20% by weight, more preferentially at least 50% by weight, even more preferentially from 80% to 100% by weight of dianhydrohexitol.

According to a first variant of the invention, the chain extender is a mixture of dianhydrohexitol and an additional chain extender other than dianhydrohexitols. The additional chain extender may be chosen from polyols having a molar mass of less than 200 g/mol, generally glycols, these glycols preferentially being chosen from 1,4-butanediol, 1,3-propanediol, hydroquinone bis(beta-hydroxyethyl) ether and mixtures of these products. The dianhydrohexitol/additional chain extender weight ratio may be greater than 1/99, generally greater than 20/80, frequently greater than 50/50. The dianhydrohexitol/additional chain extender weight ratio may be less than 99/1, or even less than 90/10.

According to a second preferred variant of the method of the invention, the chain extender (c) consists of dianhydrohexitol, that is to say that it comprises 100% by weight of dianhydrohexitol. More preferentially, the chain extender (c) is isosorbide.

Generally, the proportions of the compounds (a), (b), and (c) are fixed such that the number of isocyanate functions and the number of hydroxyl functions are in stoichiometric proportions. However, in some cases, it may be advantageous for the stoichiometric proportions to not be entirely respected. For example, the ratio of the number of isocyanate functions to the number of hydroxyl functions is between 0.9 and 1.1, preferably between 0.95 and 1.05, more preferentially between 0.97 and 1.02 and even more preferentially equal to 1. This is because if the ratio of the number of isocyanate functions to the number of hydroxyl functions is greater than 1.1, or even greater than 1.02, a polyurethane is obtained which has branching which may be detrimental to the thermoplasticity of the polyurethane. If the ratio of the number of isocyanate functions to the number of hydroxyl functions is less than 0.9 or even less than 0.97, a polyurethane is obtained which has too low a molar mass, which may lead to a reduction in the melting point.

Moreover, the proportions of the compounds (a), (b) and (c) are also fixed by the content by weight of rigid segments of the TPU that it is desired to obtain. The content of rigid segments of a TPU is defined by the percentage by weight of units of diisocyanate (b) and of chain extender (c) relative to the total weight of the TPU. In practice, it is determined from the proportions of each of these reagents employed for the manufacture of the TPU. The proportions of the compounds (a), (b) and (c) are fixed such that the content by weight of rigid segments of the TPU obtained is from 25% to 40% relative to the total weight of the TPU, more preferentially from 30% to 38%.

In a particular embodiment, the compounds (a), (b) and (c) are introduced into the extruder in the following proportions:

from 60% to 75%, preferably from 62% to 70% by weight of macrodiol (a);

from 20% to 35%, preferably from 25% to 30% by weight of diisocyanate (b); and

from 2% to 10%, preferably from 4% to 8% by weight of chain extender (c);

these percentages being expressed relative to the total weight of the compounds (a), (b) and (c) introduced into the extruder.

The catalyst (d) may be any polymerization catalyst well known to those skilled in the art for catalyzing the reaction of an isocyanate with a reactive hydrogen. Examples of such catalysts comprise organic or inorganic acid salts and organometallic derivatives of bismuth, lead, tin, antimony, uranium, cadmium, cobalt, thorium, aluminum, mercury, zinc, nickel, cerium, molybdenum, vanadium, copper, manganese and zirconium, and also phosphines and organic tertiary amines. Examples of organometallic catalysts comprise zinc octoate, tin octoate, tin oleate, dibutyltin dioctoate, dibutyltin dilaurate, dioctyltin diacetate, iron acetylacetonate and titanium tetrabutoxide. Examples of organic tertiary amines comprise triethylamine, triethylenediamine, N,N,N′,N′-tetramethylethylenediamine, N,N,N′,N′-tetraethylethylenediamine, N-methylmorpholine, N-ethylmorpholine, N,N,N′,N′-tetramethylguanidine, N,N,N′,N′-tetramethyl-1,3-diaminobutane, N,N-dimethylaminoethanol, N,N-diethylaminoethanol, diazabicyclooctane, N,N′-dimethylbenzylamine and 2-methylimidazole. The polymerization catalyst is preferably the organostannic catalyst chosen from tin octanoate, tin oleate, dibutyltin dioctoate, dibutyltin dilaurate and dioctyltin diacetate, more preferentially dibutyltin dilaurate.

The amount of catalyst (d) introduced into the extruder is generally from 1 to 1000 ppm, preferably from 10 to 500 ppm, more preferentially from 25 to 100 ppm relative to the total of the compounds (a), (b) and (c) introduced into the extruder.

The method according to the invention is carried out in an extruder. Any extruder well known to those skilled in the art may be used. The extruder may be chosen from single-screw extruders, twin-screw extruders, planetary screw extruders and microextruders. The extruder is preferably a co-rotating twin-screw extruder. It may advantageously have an L/D ratio of between 25 and 100, more preferentially between 35 and 80. An extruder comprises at least one endless screw which turns inside a cylindrical barrel regulated in terms of temperature by heating and/or cooling means which may be distributed in several sections along the extruder. The extruder generally comprises 5 to 20 sections, the first section corresponding to the feed-end of the extruder and the final section to the die, each of the sections possibly being independently regulated in terms of temperature.

The compounds (a), (b), (c) and (d) are introduced into the extruder in liquid form, for example via metering pumps. Where appropriate, the different compounds are molten and maintained in liquid form in temperature-regulated vessels before their introduction into the extruder. The compounds may be introduced simultaneously or separately into the extruder. For example, the compounds (a), (b) and (c) may be introduced at the feed-end of the extruder and the catalyst (d) may be introduced into a different section so as to obtain a homogeneous mixture of the compounds (a), (b) and (c) before initiating polymerization. Alternatively, the compounds (a), (b), (c) and (d) may be introduced simultaneously at the feed-end of the extruder.

In a particular embodiment, the dianhydrohexitol included in the chain extender (c) is kept in a regulated vessel under inert atmosphere before its introduction into the extruder. More specifically, when the dianhydrohexitol is introduced into the regulated vessel, purging with inert gas is carried out and the dianhydrohexitol is kept under inert atmosphere until its introduction into the extruder. This is because the applicant observed that oxidation of the dianhydrohexitol could adversely affect the quality of the TPUs obtained, especially their hue and their mechanical properties. Purging with inert gas is preferably carried out on each of the compounds (a), (b), (c) and (d) and they are kept under inert atmosphere until their introduction into the extruder. The content of the extruder is also advantageously kept under inert gas, for example by introducing inert gas at the feed-end of the extruder and maintaining a flow of inert gas which makes it possible to prevent the introduction of oxygen into the extruder. The flow of inert gas will be able to be for example greater than the free volume of the extruder per minute.

Mixing of the compounds (a), (b), (c) and (d) and the polymerization of said mixture are carried out in the extruder. Thus, the temperature profile of the extruder is determined such that it enables mixing of the compounds and polymerization of the mixture. It depends on the nature of the compounds (a), (b), (c) and (d) and their reactivity. In all cases, the temperature must not only be greater than the highest melting point of these compounds, to enable homogeneous mixing and polymerization, but also than the glass transition temperature of the TPU formed, to enable the extrusion thereof. Thus, too low a temperature may prolong the time needed for polymerization and reduce the extrusion rate. Conversely, too high a temperature may increase the fluidity of the TPU formed and pose problems for extrusion and pelletization. The temperature profile generally varies between 150 and 280° C., preferably between 200 and 250° C.

The residence time of the mixture in the extruder may vary as a function of the reactivity of the compounds and the reaction conditions used. The residence time is generally less than 10 minutes, preferably less than 5 minutes, more preferentially between 30 seconds and 3 minutes. These residence times are advantageous since they are compatible with an industrial method. In addition, a reduced residence time advantageously makes it possible to reduce the energy consumption of the method and to increase the production rate.

The TPU formed in this way is extruded through a die to give a rod which is then cut to obtain the TPU pellets according to the invention. The TPU rod may be cooled in a water bath before being cut into pellets.

The method according to the invention also advantageously comprises a step of drying the TPU pellets. The drying may be carried out in an oven or any other device well known to those skilled in the art suitable for drying polymer pellets. This step also has the advantage of stopping the polymerization reaction, if required.

For some applications, additives may be added to the TPU pellets in order to modify their appearance or their properties, especially their color, their opacity, their mechanical strength, their electrical properties, etc. These additives are generally added during a step of mixing, especially by extrusion, subsequent to the method according to the invention. However, such additives may be added during the method according to the invention, as long as they do not adversely affect the polymerization. Thus, these additives are preferably added after the mixing and polymerization step. These additives, which are well known to those skilled in the art, may be for example heat stabilizers, hydrolytic scission stabilizers, processing aids, pigments, dyes, fillers or fibers.

The present invention also relates to the TPU pellets obtained by the process described above.

The TPU pellets according to the invention have the advantage of having low coloration. In particular, the TPUs according to the invention have a more neutral hue than those of the TPUs obtained conventionally by reactive extrusion, using especially 1,4-butanediol as chain extender. By way of example, the coloration of the pellets according to the invention as measured using the CIELAB system, typically have a coloration that meets the conditions −1.5<a*<1 and 0<b*<7. Thus, the TPU pellets according to the invention have good colorability.

Moreover, the TPUs according to the invention have a hardness and an elongation at break comparable to a TPU obtained conventionally by reactive extrusion, using especially 1,4-butanediol as chain extender, while having better abrasion resistance. Thus, the TPUs according to the invention typically have an abrasion resistance, characterized by a loss of volume measured according to the standard ISO 4649, of less than 70 mm³. Such properties are particularly advantageous for overmolding applications and the manufacture of products intended to be in contact with the skin, for which a supple feel is sought.

### EXAMPLES

Synthesis of the TPUs

The TPUs were produced by reactive extrusion starting from a long macrodiol, namely Terathane 1000 sold by Invista (polytetramethylene ether glycol, PTMEG, 1000 g/mol) or Bester 86 sold by Rohm and Haas (polyadipate, 1000 g/mol), from 4,4-diphenylmethane diisocyanate (MDI) and a chain extender, namely isosorbide for examples 1 to 4 according to the invention and 1,4-butanediol (BDO) for comparative examples 1 and 2. The proportions of each of the reagents expressed as weight percentage are indicated in table 1 below. Dibutyltin dilaurate (DBTDL) was used as catalyst at a concentration of 50 ppm.

TABLE 1

| | | | Comp. | | | Comp. |
|---|---|---|---|---|---|---|
| | Ex. 1 | Ex. 2 | Ex. 1 | Ex. 3 | Ex. 4 | Ex. 2 |
| PTMEG | 65 | 60 | 65 | | | |
| Polyadipate | | | | 65 | 60 | 65 |
| MDI | 28.1 | 30.8 | 30.05 | 28.1 | 30.8 | 30.05 |
| BDO | | | 4.95 | | | 4.95 |
| Isosorbide | 6.9 | 9.2 | | 6.9 | 9.2 | |

The various reagents were prepared in the following way before being introduced into the extruder. The macrodiol is kept stirred in a jacketed vessel regulated at 80° C. The MDI melted beforehand at 60° C. is also kept stirred in a jacketed vessel regulated at 80° C. The BDO is metered at room temperature. The isosorbide is melted and kept stirred in a jacketed vessel regulated at 65° C. For the isosorbide, three cycles of vacuum (approximately 400 mbar for 1 minute)/inert gas stream (1 minute at 1.5 bar) are carried out before maintaining the product under a stream of inert gas. The other products are degassed under inert gas stream and maintained under this stream during use. An input of inert gas is also introduced at the feed-end of the extruder with a permanent flow rate making it possible to prevent the introduction of oxygen into the extruder (flow rate=free volume of the extruder/minute).

The TPUs were synthesized in a twin-screw extruder with a 26 mm diameter and a length equal to 50 times the diameter (50 D). The extruder consists of ten zones of length 5 D comprising a first unheated feed section and nine independent heating sections. The die is also heated independently. The screw profile used is a profile commonly used by those skilled in the art for the synthesis of TPUs.

The macrodiol, the chain extender, the MDI and the DBTDL are introduced in liquid form at the feed-end of the extruder, the total flow rate being equal to 10 kg/h. The rotation speed is fixed at 250 rpm. The residence time of the mixture in the extruder is from 1 minute and 10 seconds to 2 minutes, depending on the reaction conditions employed, and the temperature profile varies between 200 and 250° C.

The TPU rod formed at the die outlet is cooled in water and cut into pellets. The TPUs synthesized are subsequently dried at 100° C. for 2 h.

Coloration of the TPUs Synthesized

Table 2 below summarizes the coloration of the TPUs synthesized.

The coloration of the TPUs is determined on the pellets using a Konica Minolta CM-2300d spectrophotometer. 20 grams of pellets are placed in the measuring crucible. The CIELAB (L*, a*, b*) values are measured 5 times. The values indicated in table 2 below represent the mean of these 5 measurements.

TABLE 2

| | | | | Comp. | | | Comp. |
|---|---|---|---|---|---|---|---|
| | | Ex. 1 | Ex. 2 | Ex. 1 | Ex. 3 | Ex. 4 | Ex. 2 |
| Coloration | L* | 41.0 | 46.7 | 45.7 | 44.3 | 39.3 | 39.4 |
| | a | −0.53 | −0.89 | −1.62 | −1.05 | −0.91 | 1.80 |
| | b | 5.45 | 8.26 | 8.37 | 6.97 | 8.15 | 7.83 |

It should be noted that in the CIELAB system, the higher the L* value, the lighter and brighter the color measured. Moreover, neutral colors correspond to a* values (scale ranging from red for positive values to green for negative values) and b* values (scale ranging from yellow for positive values to blue for negative values) that typically meet the conditions −1.5<a*<1 and 0<b*<7. In particular, at a constant b* value, a color having a positive a* value, even weakly positive, appears less neutral than a color having a weak but negative a* value.

Thus, the TPUs of examples 1 and 3 have more neutral hues than those of the TPUs of comparative examples 1 and 2 having an identical content of rigid segments. Moreover, even with a higher content of rigid segments, the hue of the TPUs of examples 2 and 4 have hues comparable to those of the TPUs of comparative examples 1 and 2.

Mechanical Properties of the TPUs Synthesized

Table 3 below summarizes the mechanical properties of the TPUs synthesized.

The elongation at break (A%) is determined on a Lloyd machine fitted with a 10 kN sensor with a pull rate of 300 mm/min.

The Shore A hardness is measured according to standard ISO 868:2003 which consists in determining the driving in of a penetrator standardized in this field, by application of a given force.

The abrasion resistance is measured according to standard ISO 4649:2010 which consists in measuring the loss of volume of a sample after displacement of 40 linear meters on standardized abrasive paper.

TABLE 3

| | | | Comp. |
|---|---|---|---|
| | Ex. 1 | Ex. 2 | Ex. 1 |
| A % (%) | >400 | >400 | >400 |
| Hardness (ShA) | 79 | 87 | 82 |
| Abrasion (mm³) | 61 | 63 | 80 |

All three of the TPUs of examples 1 and 2 and of comparative example 1 have an equivalent hardness and a comparable elongation at break of greater than 400%, which is sufficient for most applications, especially in overmolding. On the other hand, the TPUs of examples 1 and 2 have a better abrasion resistance compared to the TPU of comparative example 1.

1. A method for manufacturing thermoplastic polyurethane pellets by reactive extrusion, comprising:
introducing, into an extruder, a macrodiol (a) of molar mass from 500 to 3000 g/mol, a diisocyanate (b), at least one chain extender (c) comprising a dianhydrohexitol and a polymerization catalyst (d), said compounds (a), (b), (c) and (d) being introduced into the extruder in liquid form;
mixing the compounds (a), (b), (c) and (d) and polymerizing said mixture in the extruder; and
extruding and cutting said polymerized mixture to form the thermoplastic polyurethane pellets.

2. The method as claimed in claim 1, wherein the ratio of the number of isocyanate functions to the number of hydroxyl functions is between 0.9 and 1.1, preferably between 0.95 and 1.05, more preferentially between 0.97 and 1.02 and even more preferentially equal to 1.

3. The method as claimed in claim 1, wherein the content by weight of rigid segments of the thermoplastic polyurethane is from 25% to 40%.

4. The method as claimed in claim 1, wherein the following are introduced into the extruder:
from 60% to 75% by weight of long macrodiol (a);
from 20% to 35% by weight of diisocyanate (b); and
from 2% to 10% by weight of chain extender (c).

5. The method as claimed in claim 1, wherein the macrodiol (a) is chosen from polyether glycols, polyester glycols, polycarbonate glycols or mixtures thereof; the macrodiol (a) is preferably a polyether glycol.

6. The method as claimed in claim 1, wherein the dianhydrohexitol (c) is isosorbide.

7. The method as claimed in claim 1, wherein the reagents (a), (b), (c) and (d) are introduced simultaneously at the extruder feed end.

8. The method as claimed in claim 1, wherein the step of mixing and polymerizing is carried out at a temperature of between 200° C. and 250° C.

9. The method as claimed in claim 1, further comprising a step of drying the thermoplastic polyurethane pellets.

10. The method as claimed in claim 1, wherein an inert gas purge is carried out on the molten isosorbide before it is introduced into the extruder; an inert gas purge is preferably carried out on each of the reagents in the melt state.

11. A thermoplastic polyurethane pellet obtained by the method as defined in claim 1.
